(19) United States
(12) Patent Application Publication
(10) Pub. No.: US 2021/0079752 A1
(43) Pub. Date: Mar. 18, 2021

(54) Machine Learning Control for Automatic Kick Detection and Blowout Prevention

(71) Applicant: Accucode AI, Dublin 2 (IE)

(72) Inventor: Karl Aric Van Camp, Las Vegas, NV (US)

(21) Appl. No.: 17/022,348

(22) Filed: Sep. 16, 2020

Related U.S. Application Data
(60) Provisional application No. 62/901,106, filed on Sep. 16, 2019.

(51) Int. Cl. E21B 33/06; G06K 9/62; G06N 3/04; G06N 5/04; H04L 12/24; E21B 44/06

(52) U.S. Cl. CPC E21B 33/06; G06K 9/6256; G06N 3/0454; E21B 44/06; G06K 9/6228; H04L 41/0806; G06N 5/04

(57) ABSTRACT

Novel tools and techniques for are provided for machine learning control of automatic kick detection and blowout prevention. A system includes one or more blowout preventers (BOP), one or more sensors, a neural network bank comprising one or more neural networks, and a machine learning (ML) controller coupled to the one or more BOPs. The ML controller includes a processor, and non-transitory computer readable media comprising instructions executable by the processor to obtain operational data associated with a local well, generate one or more feature vectors based on the operational data, and generate one or more respective kick scores. In a fully automatic operational mode, the ML controller may issue a position command based on the kick score, and in a semi-automatic operational mode, determine the position command recommended to be issued.

### CROSS REFERENCE TO RELATED APPLICATIONS

This application claims priority to U.S. Provisional Patent Application Ser. No. 62/901,106, filed Sep. 16, 2019 by Karl Aric Van Camp. (attorney docket no. 1141.01PR), entitled “Machine Learning Control for Automatic Kick Detection and Blowout Prevention,” the entire disclosure of which is incorporated herein by reference in its entirety for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to drilling equipment and control systems, and more particularly to a predictive machine learning control system for automatic kick detection and blow-out prevention.

### BACKGROUND

In oil and gas well digging, well kick and blow-outs are a major safety risk, and a danger to both crews and equipment. A kick occurs when pressure within the drilled material (also referred to as formation pressure) is greater than the hydrostatic pressure acting on the well bore. Thus, formation fluid (such as gas, oil, or water) is forced out of the formation material (such as rock) by the pressure differential between the formation pressure and the surrounding hydrostatic pressure. The formation fluid may then begin to flow into the wellbore, and up the annulus or inside the drill pipe. This is referred to as a kick.

When the kick increases and formation fluid is released in an uncontrolled manner, this may be referred to as a blowout. Blowouts may occur as surface blowouts, subsea blowouts, and in some cases, underground blowouts. Oil well control relies on blow-out preventers (BOPs) to prevent the occurrence of blowouts. A BOP stack may include one or more BOPs. A BOP stack may typically include one or more types of BOPs, including annular preventers, ram preventers, blind ram preventers, and shear ram preventers for restricting or blocking the flow of the kick. Typically, an individual BOP is manually activated remotely by the crew (e.g., electronically, hydraulically, acoustically, etc.), but may also be manually actuated by the crew locally at the BOP by mechanical actuation of the BOP. Conventionally, the BOP is activated by a crewmember when a kick or impending blowout is detected or predicted by the crewmember monitoring the well. However, well kicks are often not detected until they are past the well head and into the drill string.

Accordingly, tools and techniques for a predictive, automatic, machine learning control for kick detection and blowout prevention are provided.

### BRIEF DESCRIPTION OF THE DRAWINGS

A further understanding of the nature and advantages of the embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a schematic block diagram of an ML automatic well control system, in accordance with various embodiments;

FIG. 2 is a functional block diagram of an ML control system for automatic kick detection and BOP control, in accordance with various embodiments;

FIG. 3 is a flow diagram of a method for automated BOP control, in accordance with various embodiments;

FIG. 4 is a schematic block diagram of a computer system for an ML control system, in accordance with various embodiments; and

FIG. 5 is a schematic block diagram illustrating system of networked computer devices, in accordance with various embodiments.

### DETAILED DESCRIPTION OF CERTAIN EMBODIMENTS

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

The various embodiments include, without limitation, methods, systems, and/or software products. Merely by way of example, a method may comprise one or more procedures, any or all of which are executed by a computer system. Correspondingly, an embodiment may provide a computer system configured with instructions to perform one or more procedures in accordance with methods provided by various other embodiments. Similarly, a computer program may comprise a set of instructions that are executable by a computer system (and/or a processor therein) to perform such operations. In many cases, such software programs are encoded on physical, tangible, and/or non-transitory computer readable media (such as, to name but a few examples, optical media, magnetic media, and/or the like).

In an aspect, a system is provided for automatic kick detection and blowout prevention. The system includes one or more blowout preventers, one or more sensors, a neural network bank comprising one or more neural networks, and a machine learning (ML) controller coupled to the one or more BOPs. The ML controller includes a processor; and non-transitory computer readable media comprising instructions executable by the processor. The instructions may be executable by the processor to obtain, via the one or more sensors, operational data associated with a local well, wherein the operational data is indicative of well conditions and characteristics generate one or more feature vectors based on the operational data, and provide the one or more feature vectors to the one or more neural networks. The instructions may further be executable by the processor to generate, via the one or more neural networks, one or more respective kick scores. In a fully automatic operational mode, the instructions may be executable by the processor to issue a position command based on the kick score to each of the one or more BOPs, and in a semi-automatic operational mode, the instructions may be executable by the processor to determine the position command recommended to be issued based on the kick score for each of the one or more BOPs.

In another aspect, an apparatus is provided for automatic kick detection and blowout prevention. The apparatus includes a processor, and non-transitory computer readable media comprising instructions executable by the processor. The instructions may be executable by the processor to obtain, via one or more sensors, operational data associated with a local well, wherein the operational data is indicative of well conditions and characteristics, generate one or more feature vectors based on the operational data, provide feature vector to the one or more neural networks, and generate, via one or more neural networks, one or more respective kick scores. The instructions may further be executable to, in a fully automatic operational mode, issue a position command based on the kick score to each of one or more BOPs, and in a semi-automatic operational mode, recommend the position command to be issued based on the kick score for each of the one or more BOPs.

In a further aspect, a method for automatic kick detection and blowout prevention is provided. The method includes obtaining, via one or more sensors, operational data associated with a local well, wherein the operational data is indicative of well conditions and characteristics, generating, via a ML control system, one or more feature vectors based on the operational data, and providing, via the ML control system, the one or more feature vectors to the one or more neural networks. The method further includes generating, via one or more neural networks, one or more respective kick scores. In a fully automatic operational mode, the method continues by issuing, via the ML control system, a position command based on the kick score to each of the one or more BOPs, and in a semi-automatic operational mode, the method continues by determining, via the ML control system, a recommended position command to be issued based on the kick score for each of the one or more BOPs.

Various modifications and additions can be made to the embodiments discussed without departing from the scope of the invention. For example, while the embodiments described above refer to specific features, the scope of this invention also includes embodiments having different combination of features and embodiments that do not include all the above described features.

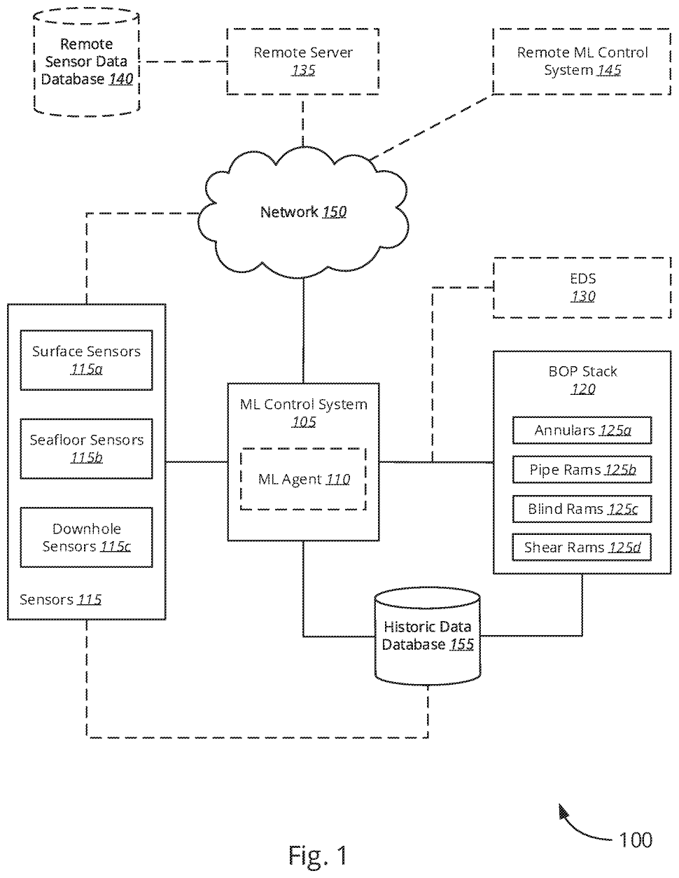

FIG. 1 is a schematic block diagram of an ML automatic well control system 100. In various embodiments, the system 100 includes an ML control system 105, ML agent 110, one or more sensors 115 including one or more surface sensors 115a, one or more seafloor sensors 115b, and one or more downhole sensors 115c, a BOP stack 120 including one or more different types of BOPs, including annulars 125a, pipe rams 125b, blind rams 125c, shear rams 125d, emergency disconnect system (EDS) 130, a remote server 135, remote sensor data database 140, remote ML control system 145, network 150, and historic data database 155. It should be noted that the various components of the system 100 are schematically illustrated in FIG. 1, and that modifications to the system 100 may be possible in accordance with various embodiments.

In various embodiments, the ML control system 105 (also referred to as an ML controller) may be coupled to the one or more sensors 115, the BOP stack 120 and/or one or more individual BOPs 125a-125d, the emergency disconnect system (EDS) 130, and the historic data database 155. In some embodiments, the ML control system 105 may further be coupled to a remote server 135 and/or remote sensor data database 140 via the network 150. In some further embodiments, the ML control system 105 may be coupled to a remote ML control system 145 via the network 150. In further embodiments, the ML control system 105 may include an ML agent 110. The one or more sensors 115 may include various types of sensors. For example, the one or more sensors 115 may include one or more surface sensors 115a, one or more seafloor sensors 115b, and one or more downhole sensors 115c. In some embodiments, the one or more sensors 115 may be coupled to the remote sensor data database 140 and/or the remote server 135 via the network 150. In some embodiments, the one or more sensors 115 may further be coupled to the remote ML control system 145. In further embodiments, the one or more sensors 115 may be coupled to the historic data database 155.

In various embodiments, the ML control system 105 may be configured to automatically detect kick and control the one or more BOPs 125a-125d of the BOP stack 120. In some embodiments, the ML control system 105 may itself include one or more respective control systems associated with control of one or more BOPs 125a-125d of the BOP stack 120. In some embodiments, the ML control system 105 may include an ML agent 110 configured to interface with each of the one or more BOPs 125a-125d of the BOP stack 120 or, alternatively, respectively the one or more control systems associated with each of the one or more BOPs 125a-125d. The ML control system 105 may therefore be configured to run an instance of the ML agent 110, which may be configured to detect kick and control the one or more BOPs 125a-125d. Thus, the ML agent 110 may include logic for detecting kick and control logic for controlling the one or more BOPs 125a-125d.

Accordingly, the ML control system 105 and/or ML agent 110 may include one or more of software, hardware (both physical and/or virtual), or a combination of hardware and software. without limitation, hardware, software, or both hardware and software. For example, in some embodiments, the ML control system 105 may include artificial intelligence (AI)/ML logic or ML agent 110, and underlying computer hardware (physical and/or virtual), configured to run the AI/ML logic. Thus, the ML control system 105 may, in some embodiments, include one or more server computers/physical host machines configured to run the ML agent 110. In some embodiments, the ML agent 110 may be configured to run locally on the ML control system 105. In some further embodiments, the ML agent 110 may be configured to establish an interface between a remote ML control system 145 and the ML control system 105. Thus, in some embodiments, the ML agent 110 may be configured to allow the remote ML control system 145 to detect and/or predict kick and to control the one or more BOPs 125a-125d of the BOP stack 120.

In further embodiments, the ML control system 105 and/or the ML agent 110 may be configured to run on a dedicated machine or appliance. Accordingly, in some embodiments, the ML agent 110 may be implemented on a separate dedicated appliance, such as single-board computers, programmable logic controller (PLC), application specific integrated circuits (ASIC), system on a chip (SoC), or other suitable device. Similarly, in some embodiments, the ML control system 105 may be implemented on dedicated hardware, such as a single-board computer, PLC, ASIC, or SoC implementation.

In some embodiments, the ML control system 105 may be configured to run in different operating modes. For example, in some embodiments, the operating modes may include semi-automatic and fully automatic. In a semi-automatic operating mode, the ML control system 105 may be configured to provide kick detection alarms in response to detecting a kick in the well, and suggest BOP commands in response to detecting and/or predicting the occurrence of a blowout and based on the severity of the kick/blowout to a crewmember and/or other user. For example, in one example, the ML control system 105 may locally detect the occurrence of a kick and alert a user, and/or detect or predict a blowout and recommend actions, such as BOP commands, to a user. In other examples, a remote ML control system 145 may detect the occurrence of a kick remotely, via network 150, and alert a user locally with the ML control system 105 and/or ML agent 110. Similarly, the remote ML control system 145 may recommend actions, such as BOP commands, in response to detecting or predicting a blowout through the ML control system 105 and/or ML agent 110 locally.

In a fully automatic operating mode, the ML control system 105 may be configured to control and activate one or more BOPs 125a-125d without input from a human input from a crewmember and/or other user. Accordingly, in some examples, the ML control system 105 may locally detect the occurrence of a kick and perform one or more actions, such as BOP commands, to operate the one or more BOPs 125a-125d automatically. Similarly, in a remote arrangement, the remote ML control system 145 may remotely control one or more BOPs 125a-125d of the BOP stack 120 via the local ML control system 105 and/or ML agent 110, which may be accessed via the network 150. For example, in some embodiments, the remote ML control system 145 may be configured to cause the ML agent 110 and/or ML control system 105 to issue commands to one or more BOPs 125a-125d of the BOP stack.

According to various embodiments, the ML control system 105, including ML control logic, and/or the ML agent 110 may include one or more neural networks. In some embodiments, in a remote configuration, the remote ML control system 145 may include the one or more neural networks. In some examples, neural networks may include two types: a shallow learning neural network and deep learning neural network. Each of the one or more neural networks may be configured to detect the occurrence a kick, and further to determine or predict that a blowout will occur based on inputs from the one or more sensors 115, historic data database 155, and remote sensor data database 140.

For example, in various embodiments, the ML control system 105, ML agent 110, and/or the remote ML control system 145 may be configured to obtain, from the one or more sensors 115, raw input data to be used by the one or more neural networks. For example, the one or more sensors 115 may include one or more surface sensors 115a, seafloor sensors 115b, and downhole sensors 115c, each configured to generate respective data streams of raw input data. Feature data may include various sensor data and other operational data used by a neural network to determine the occurrence of a kick, and further to determine one or more actions (e.g., BOP commands) to be performed. In some embodiments, the ML control system 105, ML agent 110, and/or remote ML control system 145 may be configured to obtain raw input data from the one or more sensors, historical data database 155, and/or remote sensor data database 140. For example, relevant feature data (e.g., raw input data) may include, without limitation, drilling rate, annulus flow rate, pit volume, pump speed, and pump pressure. The raw input data may be processed by the ML control logic of the ML control system 105, ML agent 110, and/or the remote ML control system 145 to generate one or more feature vectors from the raw input data in real time.

In various embodiments, different types of feature vectors may be generated by the ML logic respectively for each neural network or type of neural network. For example, raw input data, attributes derived from the raw input data, historical data, categorical field statistics, and normalization parameters may be used to construct respective feature vectors for each type of neural network in a parallel bank of neural networks. For example, different feature data may be utilized to generate a feature vector for a shallow learning neural network as compared to a deep learning neural network. Similarly, feature vectors may vary between neural networks of the same type but associated with different BOPs, such as a shallow learning neural network associated with annulars 125a as compared to a shallow learning neural network associated with the control of pipe rams 125b.

In some examples, historical rollups may be calculated in real-time from time histories of data stored in the database. Statistics, normalization parameters, network parameters, and target thresholds may be calculated during offline training and analysis, for example using historic data and/or remote sensor data form a remote sensor data database 140, which may be stored in the database, and applied to a feature vector in real-time. In some examples, flattened data may be used in shallow learning neural network feature vectors, whereas time histories may be used in deep learning neural network feature vectors. Accordingly, in various embodiments, feature vectors may be generated for each type of neural network (shallow learning and deep learning) in the parallel bank, provided to each of the neural networks, and archived in the historic data database 155.

Accordingly, in various embodiments, the one or more sensors 115 may be configured to provide real-time data streams from which feature vectors may be generated by the ML logic. Feature vectors may, in various embodiments, include search vectors comprised of a set of one or more search parameters. In some embodiments, the feature vector may be a set of feature data (obtained from the raw input data) associated with a time or window of time. The feature vectors may, in turn, be provided to each of the one or more neural networks, which may generate a kick score. The kick score may be indicative of the likelihood of the presence of a kick. For example, in some embodiments, the kick score may indicate how closely a particular feature vector, or a set of one or more feature vectors, matches respectively a target vector or set of one or more target vectors that are associated with the occurrence of a kick. In yet further embodiments, the one or more neural networks may be configured to generate a kick score further indicative of the strength (e.g., intensity) of a kick. For example, in some embodiments, the kick score may be a normalized to a value between 0 and 1, where a score of 0 indicates that no kick is present. A score approaching 1 may be indicative of a stronger kick. In some embodiments, the range of scores 0 to 1 may be normalized up to a maximum threshold strength of a kick.

In some embodiments, one or more neural networks may be configured to control each type of BOP 125a-125d of the BOP stack 120. For example, one or more neural networks may be configured to generate a kick score, which may be provided to the ML control system 105, ML agent 110, and/or the remote ML control system 145 to determine whether to activate a BOP 125a-125d. For example, the ML control system 105, ML agent 110, and/or the remote ML control system 145 may include a BOP control process configured to determine whether to activate a respective BOP 125a-125d based on the determination of the one or more neural networks. Accordingly, in various embodiments, a respective one or more neural networks may be respectively associated with each of the annulars 125a, pipe rams 125b, blind rams 125c, and/or shear rams 125d.

In some embodiments, the annulars 125a, pipe rams 125b, blind rams 125c, and shear rams 125d may be systems which have an open or closed state. In one example, as previously described, a pair of neural networks (one shallow learning and one deep learning) may be associated with each mechanical system (e.g., each of the BOPs 125a-125c) respectively. Each of the neural networks may be trained on synthetic data, historical data, and/or remote sensor data to detect the relative kick strengths and corresponding opened or closed states for the given BOP system 125a-125c. Accordingly, outputs from each of the pairs of neural networks may be sent to a respective BOP position control process for each of the annulars 125a, pipe rams 125b, blind rams 125c, and shear rams 125d for blending and thresholding to determine whether the respective BOP 125a-125d should be provided with an open or closed position command. By utilizing neural network pairs, signal confirmation and system redundancy are provided for each calculated position command. The output of each neural network and the processed position commands are archived in the historic data database 155 and, in some embodiments, fed into/mirrored by the BOP digital twin. In some further embodiments, a separate control process for an EDS 130 separate from the BOPs 125a-125d may also be associated with a neural network pair, and respectively issued commands to remain connected or disconnected from the well.

In yet further embodiments, a single ML shallow learning neural network or single deep learning neural network may be configured to receive a single input feature vector and may generate outputs at one or more respective output nodes. For example, each of the one or more output nodes may respectively be associated with a BOP position control processes for annular 125a position, pipe ram 125b position, blind ram 125c position, and shear ram 125d position. Alternatively, in yet further embodiments, additional neural networks could be added to the parallel bank (e.g., pairs of neural networks) for increased redundancy and signal confirmation. For example, in addition to the shallow learning neural network and deep learning neural network, the parallel bank of neural networks may include, for example, a remote learning neural network trained on remote sensor data, a hybrid learning neural network combining both shallow (e.g., real-time, flattened) sensor data and historic data, or other types of neural networks, which may respectively be associated with the BOPs 125a-125d of a BOP stack 120.

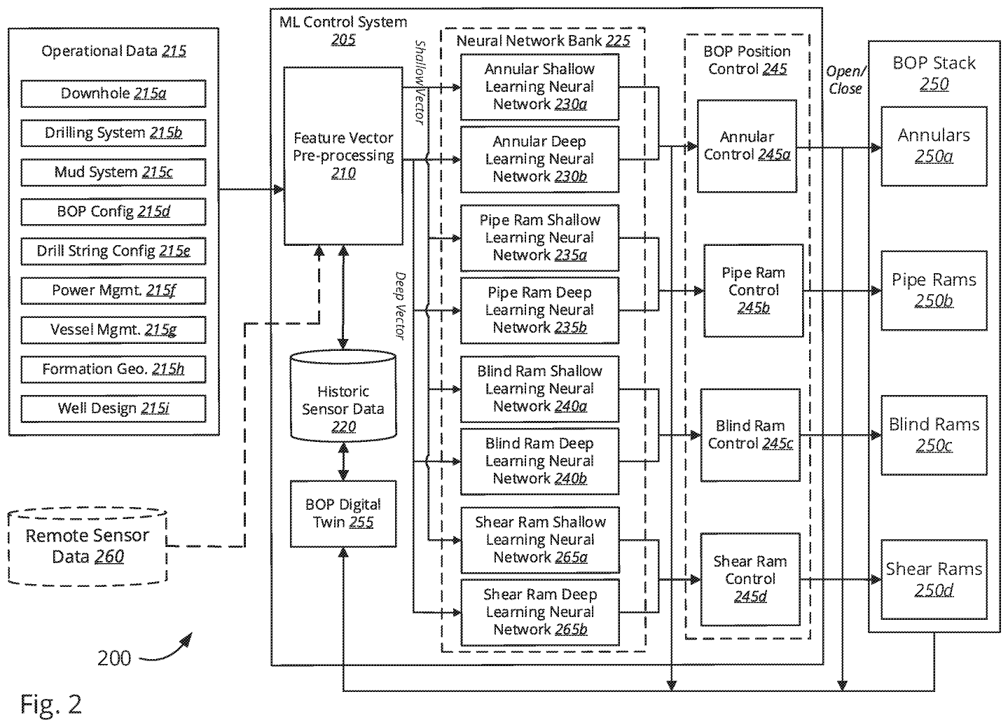

FIG. 2 is a schematic block diagram of an ML control system 200 for automatic kick detection, in accordance with various embodiments. The system 200 includes ML control system 205, feature vector pre-processing logic 210, operational data 215, historic sensor data 220, neural network bank 225, BOP position control processes 245, BOP stack 250, BOP digital twin 255, and remote sensor data 260. Operational data 215 may include data indicative of the characteristics of a well and conditions within and around the well. For example, operational data 215 may include various types of data including downhole data 215a, drilling system data 215b, mud system data 215c, BOP configuration data 215d, drill string configuration data 215e, power management data 215f, vessel management data 215g, formation geology data 215h, and well design data 215i. Neural network bank 225 includes various neural network pairs, including annular shallow learning neural network 230a, annular deep learning neural network 230b, pipe ram shallow learning neural network 235a and pipe ram deep learning neural network 235b, blind ram shallow learning neural network 240a and blind ram deep learning neural network 240b, and shear ram shallow learning neural network 265a and shear ram deep learning neural network 265b. BOP position control processes 245 includes annular control process 245a, pipe ram control process 245b, blind ram control 245c, and shear ram control 245d. BOP stack 250 includes one or more BOPs such as annulars 250a, pipe rams 250b, blind rams 250c, and shear rams 250d. It should be noted that the various components of the system 200 are schematically illustrated in FIG. 2, and that modifications to the system 200 may be possible in accordance with various embodiments.

In various embodiments, the ML control system 205 may include feature vector pre-processing logic 210, which may be coupled to the neural network bank 225. Neural network bank 225 may include one or more neural network as previously described. The outputs of the neural network bank 225 may be coupled to respective BOP position control processes 245. The BOP position control processes 245 may, in turn, be coupled to respective BOPs 250a-250d of the BOP stack 250. The ML control system 205 may further be coupled to one or more data streams of operational data 215, which may be generated by one or more respective sensors. Thus, feature vector pre-processing logic 210 may be coupled to the operational data 215. Remote sensor data 260 may further be coupled to the feature vector pre-processing logic 210.

In various embodiments, the feature vector pre-processing logic 210 may be configured to obtain operational data 215 from one or more respective sensors. Operational data 215 may include downhole data 215a, drilling system data 215b, mud system data 215c, BOP configuration data 215d, drill string configuration data 215e, power management data 215f, vessel management data 215g, formation geology data 215h, and well design data 215i. Accordingly, the operational data 215 provided to the feature vector pre-processing logic 210 may be raw data obtained from the one or more sensors. The feature vector pre-processing logic 210 may be configured to generate one or more feature vectors from the operational data 215.

In further embodiments, the feature vector pre-processing 210 may be configured to obtain historic sensor data 220 from a local and/or remote database and generate one or more feature vectors from the historic sensor data 220. Historic sensor data 220 may include historic data previously obtained from the one or more sensors, one or more historical states of the BOP digital twin 255, including outputs of the neural networks 230a, 230b, 235a, 235b, 240a, 240b, 265a, 265b of the neural network bank 225, outputs of the BOP position control processes 245a-245d, and states of the BOPs 250a-250d of the BOP stack 220. Similarly, the feature vector pre-processing logic 210 may be configured to obtain remote sensor data 260 and generate one or more feature vectors from the remote sensor data 260. Remote sensor data may include historic and/or real-time operational data. The remote sensor data may further include synthetic and/or simulated sensor data, and sensor data generated from other wells and drilling systems.

In various embodiments, the feature vector pre-processing logic 210 may be configured to transmit a feature vector to one or more neural networks 230a-240b, 265a-265b of the neural network bank 225. The neural network bank 225 may include parallel banks of neural networks. As depicted, in one example, the neural network bank 225 may include one or more pairs of neural networks, each pair of neural networks associated with a respective BOP position control process 245. For example, the neural network bank 225 may include a pair of neural networks associated with the annular control process 245a: an annular shallow learning neural network 230a and annular deep learning neural network 230b. The neural network bank 225 may additionally include a pair of neural networks associated with the pipe ram control process 245b: a pipe ram shallow learning neural network 235a and pipe ram deep learning neural network 235b; a pair of neural networks associated with the blind ram control process 245c: a blind ram shallow learning network 240a and blind ram deep learning neural network 240b; and a pair of neural networks associated with the shear ram control process 245d: a shear ram shallow learning network 265a and shear ram deep learning neural network 265b.

According to various embodiments, the feature vector pre-processing logic 210 may be configured to generate a respective vector for each type of neural network in the neural network bank 225. For example, in some embodiments, the feature vector pre-processing logic 210 may be configured to generate a shallow learning feature vector (“shallow vector”) and transmit the shallow vector to each of the annular shallow learning neural network 230a, pipe ram shallow learning neural network 235a, blind ram shallow learning network 240a, and shear ram shallow learning network 265a. The shallow vector may, in some examples, be generated based on flattened, real-time operational data 215. Flattened, real-time operational data 215 may include, without limitation, raw data from the one or more sensors and/or attributes derived from the raw data, constructed in real-time from real-time sensor data and/or sensor data generated within a recent time window (e.g., within the last 30 minutes, within the last hour, within the last 24 hours, etc.).

Operational data 215 may include, but is not limited to, downhole data 215a, drilling system data 215b, mud system data 215c, BOP configuration data 215d, drill string configuration data 215e, power management data 215f, vessel management data 215g, formation geology data 215h, and well design data 215i. Downhole data 215a may include, for example, measurements of pressure, temperature, acceleration, drill head speed (e.g., drill head revolutions per minute (RPM)), drilling direction, and flowrates at the drill head. Drilling system data 215b may include, for example, measurements of rate of penetration, drill string speed (e.g., drill string RPM), weight on drill bit, standpipe manifold pressures, choke manifold pressures, and kill manifold pressures. Mud system data 215c may include, for example, measurement of mud pump online configuration, strokes per minute, mud weight out, return mud weight, mud flow rate, fluid properties, and pit levels. BOP configuration data 215d may include, for example, annular configuration data, pipe ram configuration data, and shear ram configuration data, such as target wellbore pressure, threshold wellbore pressure, maximum wellbore pressure, and operational pressure for respective BOPs. Drill string configuration data 215e may include, for example, drill string composition data (including numbers and types of casing and/or drill pipe in the drill string), and drill string geometry data (including lengths, diameters, and composite weight). Power management data 215f may include, for example, vessel system power consumption levels and power available levels. Vessel management data 215g may include, for example, dynamic positioning system parameters, watch circle parameters, position and orientation parameters, thruster parameters, and wind and sea current parameters. Formation geology data 215h may include resistivity and density of the formation material in various parts of the well, including at the well head, wellbore, and in at the drill head. Well design data 215i may include, for example, the dimensions of the well including width and depth information, radii of curvature in various parts of the well, and other suitable design information regarding the geometry and design of a well.

Similarly, the feature vector pre-processing logic 210 may be configured to generate a deep learning feature vector (“deep vector) and transmit the deep vector to each of the annular deep learning neural network 230b, pipe ram deep learning neural network 235b, blind ram deep learning network 240b, and shear ram deep learning network 265b. In various embodiments, the deep vector may be generated based on historical sensor data 220/historical rollups. In some embodiments, historical sensor data 220 may be obtained from a historic sensor data database, including time histories of sensor data. Historical rollups may be calculated in real-time from time histories of data stored in the database. Categorical statistics, normalization parameters, network parameters, and target thresholds may be calculated during offline training and analysis, stored in the historic sensor data database, and applied to a feature vector in real-time. Accordingly, the deep vector may be generated in real-time, from current operational data 215 (e.g., raw input data and parameters derived from the raw input data), as well as categorical field statistics, and normalization parameters, network parameters, and target thresholds as determined above based on the historical sensor data 220.

In yet further embodiments, additional types of neural networks may be included in the neural network bank 225, or fewer types of neural networks may be used in the neural network bank 225. For example, as previously described, in some embodiments, a single ML shallow learning neural network or single deep learning neural network may be configured to receive a single input feature vector and may generate outputs at one or more respective BOP position control processes 245. Alternatively, in yet further embodiments, additional neural networks could be added to the neural network bank 225 for increased redundancy and signal confirmation. For example, in addition to the shallow learning neural network and deep learning neural network, the parallel bank of neural networks may include, for example, a remote learning neural network trained on remote sensor data 260, a hybrid learning neural network combining both shallow (e.g., real-time, flattened) sensor data, historic data 220, and remote sensor data 260, or other types of neural networks. Accordingly, the feature vector pre-processing logic 210 may further be configured to generate a respective vector for any additional neural network based on the type of neural network and features on which the neural network may be trained. For example, in some further embodiments, the feature vector pre-processing logic 210 may be configured to generate a vector based on operation data 215 and remote sensor data 260. The remote sensor data 260 may include historic data obtained from other wells and/or drilling operations. Thus, as with the deep vector, categorical statistics, normalization parameters, network parameters, and target thresholds may be calculated during offline training and analysis, stored in a remote sensor data database, and applied to a respective feature vector in real-time.

In various embodiments, the neural networks may be trained based on the one or more data streams of real-time data, such as operational data 215, historic sensor data 220, and remote sensor data 260. For example, the neural networks may be trained to predict and/or determine the occurrence of a well kick based on the operational data, historic sensor data, remote sensor data 260, and/or simulated data. For example, various operational data 215, including raw data and derived parameters, and states of the various sensors, well configurations, and state of the wells may be used by the neural networks to determine a likelihood that a kick has or will occur. In some embodiments, the neural networks may be provided with operational data from other wells, such as remote sensor data 260 corresponding to when a well kick has occurred at a respective well. The neural network may further be provided with historic sensor data 220 associated with a well kick that has previously occurred in the well currently monitored by the ML control system 205 (e.g., the well). In further embodiments, the neural networks of the neural network bank 225 may be provided with simulated data to simulate conditions (e.g., raw data and derived parameters, configuration data, and other operational data) when a well kick occurs. Thus, the neural networks may be trained to identify various feature sets associated with well kicks (e.g., feature selection), and further to associate the various feature sets with the severity of kick. In some further embodiments, the neural networks of the neural network bank 225 may be trained on different feature data. For example, different sets of historic sensor data 220, remote sensor data 260, and simulated may be utilized to train shallow learning neural networks and deep learning neural networks.

Accordingly, in various embodiments, real-time feature vectors may be presented to the trained neural networks based on real-time operational data 215. Neural networks 230a-240b, 265a-265b may be configured to generate kick scores based on the respective feature vectors (e.g., shallow vector and deep vector) provided by the feature vector pre-processing logic 210. In some embodiments, outputs from each of the respective pairs of neural networks 230a-240b, 265a-265b may be transmitted to each BOP position control process 245 (annular control process 245a, pipe ram control process 245b, blind ram control process 245c, shear ram control process 245d). For example, the annular shallow learning neural network 230a and annular deep learning neural network 230b may each output a respective kick score to the respective BOP position control process 245: the annular control process 245a. Similarly, the pipe ram shallow learning neural network 235a and pipe ram deep learning neural network 235b may each output a respective kick score to the pipe ram control process 245b, the blind ram shallow learning neural network 240a and blind ram deep learning neural network 240b may each output a respective kick score to the blind ram control process 245b, and the shear ram shallow learning neural network 265a and shear ram deep learning neural network 265b may each output a respective kick score to the shear ram control process 245d.

In various embodiments, each respective control process 245a-245d of the BOP position control processes 245 may be configured to process the kick scores to determine an output. For example, each of respective control process 245a-245d may respectively weigh kick scores from each of the shallow learning neural networks and deep learning neural networks. Thus, depending on the specific BOP position control process 245, kick scores may be weighted differently. For example, the annular control process 245a may weigh a first kick score generated by the annular shallow learning neural network 230a equally with a second kick score generated by the annular deep learning neural network 230b. In contrast, the pipe ram control process 245b may more heavily weigh a kick score generated by the pipe ram deep learning neural network 235b relative to a kick score generated by the pipe ram shallow learning neural network 235a. The blind ram control process 245c and/or shear ram control process 245d may similarly weigh a kick score generated by the respective blind ram/shear ram deep learning neural network 240b, 265b more heavily than a kick score generated by the blind ram/shear ram shallow learning neural network 240a, 265a.

Each respective control process 245a-245d may further be configured to determine kick score thresholds. Kick score thresholds may include, for example, thresholds for individual kick scores for each respective kick score. In some embodiments, a threshold may be determined for each of the one or more neural networks 230a-240b, 265a-265b individually. In further embodiments, thresholds may be determined for one or more overall kick scores. Overall kick scores may be a normalized sum of one or more weighted kick scores (e.g., normalized to a value between 0 and 1). The overall kick score may, in some examples, be referred to as a composite kick score or blended kick score. In some embodiments, an overall annular kick score may be a sum of the weighted kick score generated by the annular shallow learning neural network 230a and the weighted kick score generated by the annular deep learning neural network 230b. In some embodiments, the summed weighted kick scores may further be normalized to produce the overall annular kick score. Similarly, a pipe ram overall kick score may be a sum of the weighted kick score generated by the pipe ram shallow learning neural network 235a and the weighted kick score generated by the pipe ram deep learning neural network 235b. A blind ram overall kick score may be a sum of the weighted kick score generated by the blind ram shallow learning neural network 240a and the weighted kick score generated by the blind ram deep learning neural network 240b. A shear ram overall kick score may be a sum of the weighted kick score generated by the shear ram shallow learning neural network 265a and the weighted kick score generated by the shear ram deep learning neural network 265b. The overall kick score may further include a normalized sum of one or more of the annular overall kick score, pipe ram overall kick score, and shear ram overall kick score. Accordingly, kick score thresholds may include threshold kick scores for individual kick scores and overall kick scores.

Accordingly, in some embodiments, each of the respective BOP position control processes 245a-245d may be configured to issue a command based on the determined thresholds. For example, in some embodiments, the ML control system 205 may be configured to operate in one or more operational modes. For example, as previously described, the one or more operational modes may include a fully automatic operational mode and a semi-automatic operational mode. Thus, in a fully automatic operational mode, the BOP position control processes 245 may be configured to issue an open position command or close position command to a respective BOP 250a-250d of the BOP stack 250, and to alert a user through the ML control system 205 and/or BOP digital twin 255, as will be discussed below. In the semi-automatic operational mode, the BOP position control processes 245 may be configured, instead, to alert a user and/or generate a recommended position command (e.g., open or close position command), which may then be presented to a user via the BOP digital twin 255 and/or the ML control system 205.

In one example, in the fully automatic operational mode, an annular control process 245a may be configured to activate the annulars 250a by issuing a close position command in response to determining that any of the individual kick scores (e.g., either of the annular shallow learning neural network 230a or annular deep learning neural network 230b) has exceeded a respective individual kick score threshold. The annular control process 245a may further be configured to activate the annulars 250a by issuing a close position command in response to determining that the overall annular kick score or any other combination of overall annular kick scores has exceeded respective kick score thresholds. In contrast, the pipe ram control 245b may require both individual kick scores (e.g., from both the pipe ram shallow learning neural network 235a and pipe ram deep learning neural network 235b) to exceed the respective kick score thresholds, or for an overall pipe ram kick score to exceed a respective overall kick score threshold. Similarly, the blind ram control 245c and shear ram control 245d may require both individual kick scores (e.g., from the respective pairs of blind ram shallow learning neural network 240a and blind ram deep learning neural network 240b, and shear ram shallow learning neural network 265a and shear ram deep learning neural network 265b, respectively) to exceed the respective kick score thresholds, or for an overall shear ram kick score to exceed a respective overall kick score threshold. Accordingly, in various embodiments, the BOP position control processes 245 may be implemented in the ML control system 205. The outputs of the BOP control processes 245a-245d may be interfaced to, for example, a PLC or other circuitry which may further be integrated into the manual switch circuitry of any operational BOP 250a-250d of the BOP stack for automatic control of the respective BOPs 250a-250d. In the semi-automatic operational mode, the respective BOP position control processes 245a-245d may generate recommended position commands to be taken as opposed to transmitting the position commands to the respective BOPs 250a-250d, which may be displayed or otherwise presented via the BOP digital twin 255.

In various embodiments, the kick score thresholds (individual and overall) associated with the annular control process 245a may be lower than the kick score thresholds associated with the pipe ram control process 245b, blind ram control process 245c, and shear ram control process 245d. The kick score thresholds (individual and/or overall) associated with the pipe ram control process 245b may be higher than the kick score thresholds associated with the annular control process 245a and lower than kicks core thresholds associated with the blind ram control process 245c, and shear ram control process 245d. The kick score thresholds (individual and/or overall) for the blind ram control process 245c and/or shear ram control process 245d may, in turn, be higher than both the annular control process 245a and pipe ram control process 245b. Accordingly, higher thresholds may correspond to a higher confidence in the occurrence of a kick and/or a higher strength of a detected or predicted well kick. Thus, in various embodiments, higher thresholds may be used in order to activate and/or recommend activation of the blind rams 250c and shear rams 250d, relative to pipe rams 250b and annulars 250a. Similarly, a higher threshold may be utilized in order to activate the pipe rams 250b relative to the annulars 250a, but the threshold for the pipe rams 250b may be lower than for the blind rams 250c and shear rams 250d.

In various embodiments, the output of each of the neural networks 230a-240b, 265a-265b of the neural network bank 225, such as respective individual kick scores and overall kick scores, the outputs of each of the BOP position control processes 245a-245d, such as position commands, alerts, and/or position command recommendations, and the states of the respective BOPs 250a-250d of the BOP stack 250 may be archived, for example in a historic data database, and fed back into the BOP digital twin 255.

In various embodiments, the BOP digital twin 255 may be a digital representation of the BOP stack 250 in real-time and reflect an actual state of each of the BOPs 250a-250d of the BOP stack 250, and a commanded state of the BOP stack 250. In some embodiments, the BOP digital twin 255 may display in real-time the actual state and commanded state of the BOP stack 250 to a user via the ML control system 205. In some embodiments, individual kick scores calculated by each neural network and overall kick scores (e.g., summed and normalized kick scores) with thresholds may also displayed via the BOP digital twin 255. The BOP digital twin 255 may further be configured to provide alarms for kicks approaching and/or exceeding thresholds (e.g., visual and/or audible), and alerts for actual BOP states being mismatched from commanded BOP states and commanded BOP configuration changes. Alerts, recommendations (e.g., recommended position commands), BOP state and configuration data, and other information about the BOP stack 250 may accordingly be displayed in real-time, reflecting current BOP state. In further embodiments, the state of the BOP digital twin 255 may be stored in a historic data database for later analysis and/or as a source for historic sensor data 220.

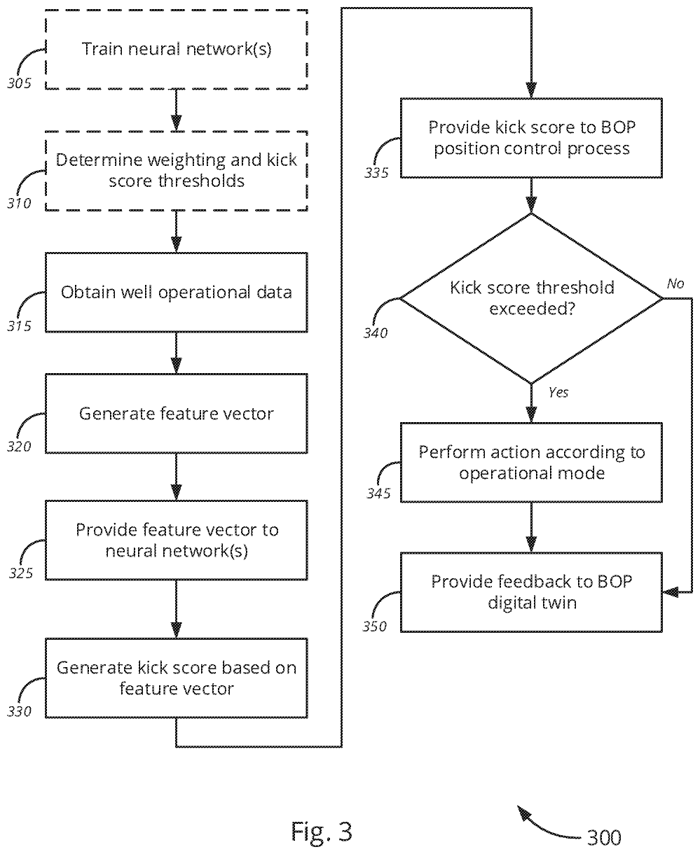

FIG. 3 is a flow diagram of a method 300 for automated BOP control, in accordance with various embodiments. The method 300 begins, at block 305, by training one or more neural networks. As previously described, in various embodiments, the one or more neural networks may be trained based on synthetic data, historical data, and/or remote sensor data to detect the occurrence of a kick, kick strength, and corresponding opened or closed states (e.g., whether a given BOP was previously actives or should be activated). In some embodiments, training the one or more neural networks may include generating, with feature vector pre-processing logic, one or more feature vectors based on the synthetic data, historical data, and/or remote sensor data. The feature vectors may then be given to the neural networks along with corresponding outcomes to train the neural network.

The method 300 continues, at block 310, by determining weighting and kick score thresholds. In various embodiments, kick scores from each of the neural networks may be respectively weighted by one or more BOP control processes. For example, a first BOP control process, such as an annular control process, may weight kick scores from a shallow learning neural network differently than a second BOP control process, such as a pipe ram control process. The pipe ram control process, in turn, may weigh kick scores from a shallow learning neural network differently than it is weighed in a third BOP control process, such as shear ram control process. In various embodiments, determining kick score thresholds may include determining thresholds for activating one or more BOPs. Thresholds may be determined for individual kick scores for each BOP control process, or overall kick score thresholds. For example, individual kick score thresholds may correspond to kick scores generated by individual neural networks. Overall kick thresholds may correspond to over kick scores generated by summing and/or normalizing one or more kick scores from individual neural networks. For example, Overall kick scores may be a normalized sum of one or more weighted kick scores (e.g., normalized to a value between 0 and 1). Accordingly, kick score thresholds may include threshold kick scores for individual kick scores and/or overall kick scores.

The method continues, at block 315, by obtaining well operational data. In various embodiments, an ML control system may be configured to obtain well operational data from one or more sensors. The sensors may include various types of well sensors, downhole sensors, surface sensors, and seafloor sensors. Operational data may refer to the various data streams generated by the one or more sensors. Operational data may include raw data generated by the sensors. For example, in some embodiments, operational data may include, without limitation, downhole data, drilling system data, mud system data, BOP configuration data, drill string configuration data, power management data, vessel management data, formation geology data, and well design data.

The method 300 further includes, at block 320, generating a feature vector. In various embodiments, the ML control system may be configured to pre-process the operational data it obtains to generate a feature vector. In some embodiments, the ML control system may include feature vector pre-processing logic configured to generate one or more feature vectors based on the operational data. In some embodiments, the feature vector pre-processing logic may be configured to generate feature vectors based on one or more of the raw input data, parameters derived from the raw input data, historical data, remote data, and/or synthetic data. In some embodiments, one or more feature vectors may be generated from the operational data. For example, a feature vector may be generated for shallow learning neural networks that is different from a feature vector generated for deep learning neural networks. Accordingly, the feature vector pre-processing logic may be configured to generate a respective feature vector each of one or more neural networks.

At block 325, the method 300 continues by providing the feature vector to the one or more neural networks. For example, in some embodiments, the feature vector pre-processing logic may be configured to provide a respective feature vector to a neural network bank. The neural network bank may comprise one or more parallel pairs of neural networks. Each of the pairs of neural networks may include a shallow learning neural network and a deep learning neural network. Each of the pairs of neural networks may further be associated with a respective BOP position control process. In some embodiments, a shallow vector may be provided to each of the shallow learning neural networks, and a deep vector may be provided to each of the deep learning neural networks of the neural network bank. In yet further embodiments, each of the one or more neural networks may be provided with a respective feature vector. For example, an annular shallow learning neural network may further be provided with a different feature vector from a pipe ram shallow learning neural network.

At block 330, a kick score may be generated respectively by each of the one or more neural networks. As previously described, the kick score may be indicative of the likelihood of the presence of a kick. For example, in some embodiments, the kick score may indicate how closely a particular feature vector, or a set of one or more feature vectors, matches respectively a target vector or set of one or more target vectors that are associated with the occurrence of a kick. In yet further embodiments, the one or more neural networks may be configured to generate a kick score further indicative of the strength (e.g., intensity) of a kick. For example, in some embodiments, the kick score may be a normalized to a value between 0 and 1, where a score of 0 indicates that no kick is present. A score approaching 1 may be indicative of a stronger kick. In some embodiments, the range of scores 0 to 1 may be normalized up to a maximum threshold strength of a kick. In some embodiments, each of the one or more neural networks may generate different kick scores. For example, in some embodiments, an annular shallow learning neural network may generate a different kick score than a pipe ram shallow learning neural network, while in other embodiments, identical kick scores may be calculated by both shallow learning neural networks.

At block 335, kick scores may be provided by the one or more neural networks to a respective BOP position control process. For example, as previously described, BOP position control processes may include respective position control processes for respective BOPs of a BOP stack. For example, an annular position control process may be configured to determine whether to activate the annulars of a BOP stack, or to recommend a position command that should be given to the annulars. The BOP position control processes may further include pipe ram position control process, blind ram position control process, and shear ram position control processes. The blind ram position control process may, in some embodiments, be configured to determine whether a drill string is present before determining whether to activate the blind rams of a BOP stack. BOP position control process may further be configured to weight and normalize individual kick scores and determine overall kick scores according to the weights previously determined at block 310.

At decision block 340, it is determined, by each respective BOP position control process, whether the kick score has exceeded a respective threshold. As previously determined, at block 310, the BOP position control process may determine whether any individual kick scores and/or overall kick scores have exceeded the respective kick score thresholds. For example, some BOP position control processes may be configured to determine whether one or more of the individual kick scores (e.g., a kick score generated by the shallow learning neural network or kick score generated by the deep learning neural network) has exceeded a respective kick score threshold. In some embodiments, a kick score threshold for the shallow learning neural network may be different from the kick score threshold for deep learning neural network, while in other embodiments, the scores may be normalized such that kick score thresholds may be consistent between the different types of neural networks. In other embodiments, some BOP position control processes may be configured to determine whether any overall kick scores have exceeded an overall kick score threshold. Overall kick score thresholds may be associated with different respective combinations of kick scores from one or more different neural networks. For example, an overall kick score may correspond to a weighted, normalized sum of kick scores generated by a shallow learning neural network and deep learning neural network associated with annulars. In other embodiments, the overall kick score may be a weighted, normalized sum of kick scores generated by all shallow learning neural networks. In yet further embodiments, other combinations of kick scores may be weighted, summed, and normalized associated with different types of neural network and different BOPs (e.g., an annular shallow learning neural network, annular deep learning neural network, and a deep learning neural network associated with the pipe rams), and overall kick score thresholds determined for the respective composite overall kick scores.

If it is determined that the kick score threshold has been exceeded, the method 300 continues, at block 345, by performing an action according to the operational mode of the ML control system. In some embodiments, in a fully automatic operational mode, the BOP position control process may be configured to automatically operate the BOPs. For example, in some embodiments, the BOP position control processes may respectively be interfaced with mechanical control circuitry for each respective BOP. In some embodiments, the BOP position control process may issue a position command to each of the respectively associated BOPs via the aforementioned interface. For example, an annular position control process may determine that one or more of its respective kick score thresholds have been exceeded, while the pipe ram and shear ram position control processes may determine that its respective kick score thresholds have not been exceeded. In this example, the annular position control process may issue a close position command to the annulars to activate the annulars (e.g., cause the annulars to close). The pipe ram and shear ram BOP position control processes may be configured to issue open position commands to the pipe rams and shear rams, respectively (e.g., causing the pipe rams and shear rams to remain in the opened state). In a semi-automatic mode, the annular control process may, instead determine a recommended position command to be issued to the respective BOPs, and present the recommended position command, for example, via the ML control system (such as through the BOP digital twin). In various embodiments, each of the BOP position control processes may further generate alerts, in either operational mode, indicative of the action performed by the respective BOP position control process.

At block 350, whether kick score threshold has or has not been exceeded, the BOP digital twin is provided with feedback reflecting the current state of the BOP stack and commanded state of the BOP stack. As previously described, in various embodiments, the output of each of the neural networks (such as respective individual kick scores and overall kick scores), the outputs of each of the BOP position control processes (such as position commands, alerts, and/or position command recommendations), and the states of the respective BOPs (e.g., opened/closed) may be archived, for example in a historic data database, and fed back to the BOP digital twin. In various embodiments, the BOP digital twin may be a digital representation of the BOP stack in real-time and reflect an actual state of each of the BOPs, and a commanded state of the BOPs. In some embodiments, the BOP digital twin 255 may display in real-time the actual state and commanded state of the BOP stack to a user via the ML control system. In some embodiments, individual kick scores calculated by each neural network and overall kick scores (e.g., summed and normalized kick scores) with thresholds may also displayed via the BOP digital twin. The BOP digital twin may further be configured to provide alarms for kicks approaching and/or exceeding thresholds (e.g., visual and/or audible), and alerts for actual BOP states being mismatched from commanded BOP states and commanded BOP configuration changes. Alerts, recommendations (e.g., recommended position commands), BOP state and configuration data, and other information about the BOP stack may accordingly be displayed in real-time, reflecting current BOP state.

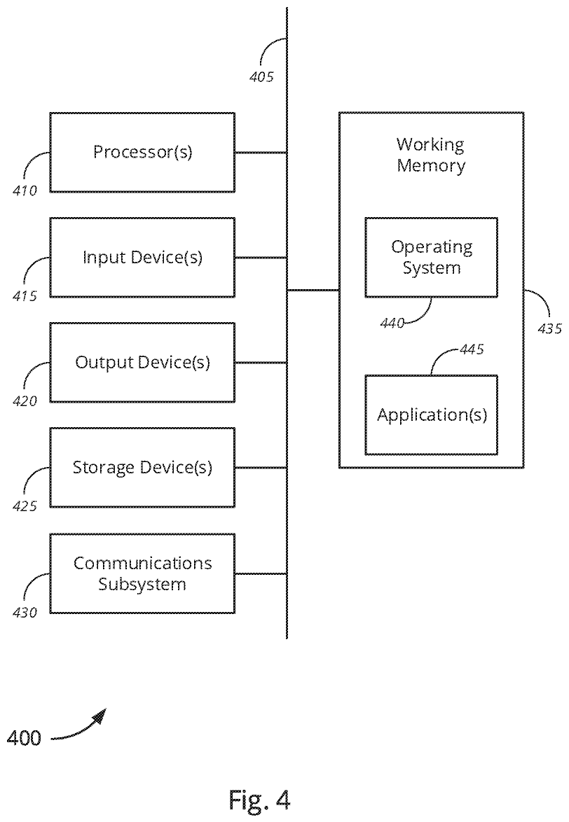

FIG. 4 is a schematic block diagram of a computer system 400 for an ML control system, in accordance with various embodiments. The computer system 400 is a schematic illustration of a computer system (physical and/or virtual), such as the ML control system, one or more neural networks, remote server, remote ML control system, BOP controllers, and other systems, which may perform the methods provided by various other embodiments, as described herein. It should be noted that FIG. 4 only provides a generalized illustration of various components, of which one or more of each may be utilized as appropriate. FIG. 4, therefore, broadly illustrates how individual system elements may be implemented in a relatively separated or relatively more integrated manner.

The computer system 400 includes multiple hardware (or virtualized) elements that may be electrically coupled via a bus 405 (or may otherwise be in communication, as appropriate). The hardware elements may include one or more processors 410, including, without limitation, one or more general-purpose processors and/or one or more special-purpose processors (such as microprocessors, digital signal processing chips, graphics acceleration processors, and microcontrollers); one or more input devices 415, which include, without limitation, a mouse, a keyboard, one or more sensors, and/or the like; and one or more output devices 420, which can include, without limitation, a display device, and/or the like.

The computer system 400 may further include (and/or be in communication with) one or more storage devices 425, which can comprise, without limitation, local and/or network accessible storage, and/or can include, without limitation, a disk drive, a drive array, an optical storage device, solid-state storage device such as a random-access memory (“RAM”) and/or a read-only memory (“ROM”), which can be programmable, flash-updateable, and/or the like. Such storage devices may be configured to implement any appropriate data stores, including, without limitation, various file systems, database structures, and/or the like.

The computer system 400 may also include a communications subsystem 430, which may include, without limitation, a modem, a network card (wireless or wired), an IR communication device, a wireless communication device and/or chip set (such as a Bluetooth™ device, an 802.11 device, a WiFi device, a WiMax device, a WWAN device, a low-power (LP) wireless device, a Z-Wave device, a ZigBee device, cellular communication facilities, etc.). The communications subsystem 430 may permit data to be exchanged with a network (such as the network described below, to name one example), with other computer or hardware systems, between data centers or different cloud platforms, and/or with any other devices described herein. In many embodiments, the computer system 400 further comprises a working memory 435, which can include a RAM or ROM device, as described above.

The computer system 400 also may comprise software elements, shown as being currently located within the working memory 435, including an operating system 440, device drivers, executable libraries, and/or other code, such as one or more application programs 445, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code may be encoded and/or stored on a non-transitory computer readable storage medium, such as the storage device(s) 425 described above. In some cases, the storage medium may be incorporated within a computer system, such as the system 400. In other embodiments, the storage medium may be separate from a computer system (i.e., a removable medium, such as a compact disc, etc.), and/or provided in an installation package, such that the storage medium can be used to program, configure, and/or adapt a general purpose computer with the instructions/code stored thereon. These instructions may take the form of executable code, which is executable by the computer system 400 and/or may take the form of source and/or installable code, which, upon compilation and/or installation on the computer system 400 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, single board computers, FPGAs, ASICs, and SoCs) may also be used, and/or particular elements may be implemented in hardware, software (including portable software, such as applets, etc.), or both. Further, connection to other computing devices such as network input/output devices may be employed.

As mentioned above, in one aspect, some embodiments may employ a computer or hardware system (such as the computer system 400) to perform methods in accordance with various embodiments of the invention. According to a set of embodiments, some or all of the procedures of such methods are performed by the computer system 400 in response to processor 410 executing one or more sequences of one or more instructions (which may be incorporated into the operating system 440 and/or other code, such as an application program 445 or firmware) contained in the working memory 435. Such instructions may be read into the working memory 435 from another computer readable medium, such as one or more of the storage device(s) 425. Merely by way of example, execution of the sequences of instructions contained in the working memory 435 may cause the processor(s) 410 to perform one or more procedures of the methods described herein.

The terms “machine readable medium” and “computer readable medium,” as used herein, refer to any medium that participates in providing data that causes a machine to operate in a specific fashion. In an embodiment implemented using the computer system 400, various computer readable media may be involved in providing instructions/code to processor(s) 410 for execution and/or may be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 425. Volatile media includes, without limitation, dynamic memory, such as the working memory 435. In some alternative embodiments, a computer readable medium may take the form of transmission media, which includes, without limitation, coaxial cables, copper wire and fiber optics, including the wires that comprise the bus 405, as well as the various components of the communication subsystem 430 (and/or the media by which the communications subsystem 430 provides communication with other devices). In an alternative set of embodiments, transmission media can also take the form of waves (including, without limitation, radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 410 for execution. Merely by way of example, the instructions may initially be carried on a magnetic disk and/or optical disc of a remote computer. A remote computer may load the instructions into its dynamic memory and send the instructions as signals over a transmission medium to be received and/or executed by the computer system 400. These signals, which may be in the form of electromagnetic signals, acoustic signals, optical signals, and/or the like, are all examples of carrier waves on which instructions can be encoded, in accordance with various embodiments of the invention.

The communications subsystem 430 (and/or components thereof) generally receives the signals, and the bus 405 then may carry the signals (and/or the data, instructions, etc. carried by the signals) to the working memory 435, from which the processor(s) 410 retrieves and executes the instructions. The instructions received by the working memory 435 may optionally be stored on a storage device 425 either before or after execution by the processor(s) 410.

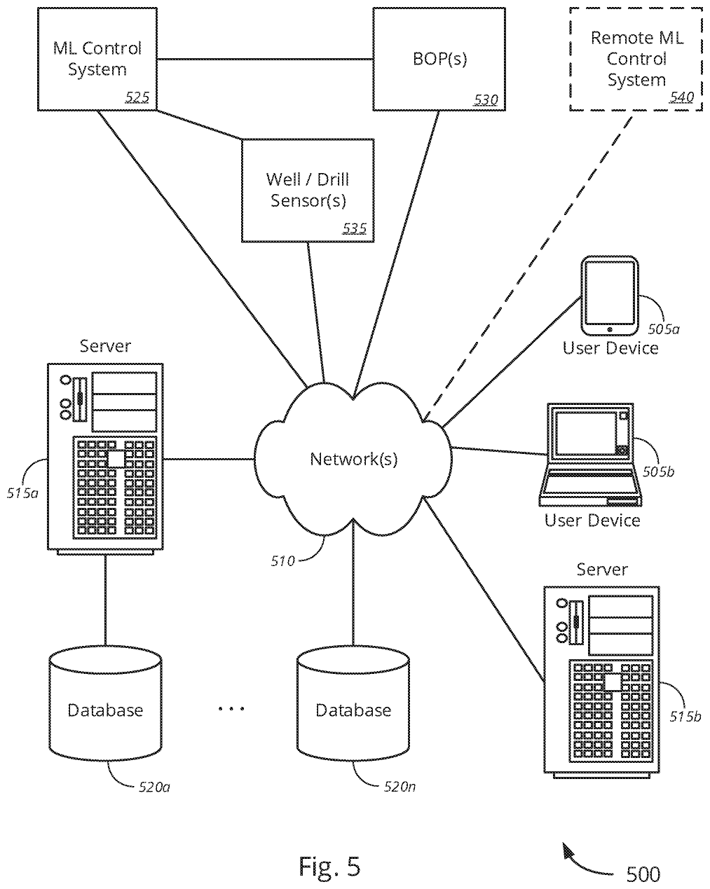

FIG. 5 is a schematic block diagram illustrating system of networked computer devices, in accordance with various embodiments. The system 500 may include one or more user devices 505. A user device 605 may include, merely by way of example, desktop computers, single-board computers, tablet computers, laptop computers, handheld computers, edge devices, and the like, running an appropriate operating system. User devices 505 may further include external devices, remote devices, servers, and/or workstation computers running any of a variety of operating systems. A user device 505 may also have any of a variety of applications, including one or more applications configured to perform methods provided by various embodiments, as well as one or more office applications, database client and/or server applications, and/or web browser applications. Alternatively, a user device 505 may include any other electronic device, such as a thin-client computer, Internet-enabled mobile telephone, and/or personal digital assistant, capable of communicating via a network (e.g., the network(s) 510 described below) and/or of displaying and navigating web pages or other types of electronic documents. Although the exemplary system 500 is shown with two user devices 505a-505b, any number of user devices 505 may be supported.

Certain embodiments operate in a networked environment, which can include a network(s) 510. The network(s) 510 can be any type of network familiar to those skilled in the art that can support data communications, such as an access network, core network, or cloud network, and use any of a variety of commercially-available (and/or free or proprietary) protocols, including, without limitation, MQTT, CoAP, AMQP, STOMP, DDS, SCADA, XMPP, custom middleware agents, Modbus, BACnet, NCTIP, Bluetooth, Zigbee/Z-wave, TCP/IP, SNA™, IPX™, and the like. Merely by way of example, the network(s) 510 can each include a local area network (“LAN”), including, without limitation, a fiber network, an Ethernet network, a Token-Ring™ network and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the network may include an access network of the service provider (e.g., an Internet service provider (“ISP”)). In another embodiment, the network may include a core network of the service provider, backbone network, cloud network, management network, and/or the Internet.

Embodiments can also include one or more server computers 515. Each of the server computers 515 may be configured with an operating system, including, without limitation, any of those discussed above, as well as any commercially (or freely) available server operating systems. Each of the servers 515 may also be running one or more applications, which can be configured to provide services to one or more clients 505 and/or other servers 515.

Merely by way of example, one of the servers 515 may be a data server, a web server, orchestration server, authentication server (e.g., TACACS, RADIUS, etc.), cloud computing device(s), or the like, as described above. The data server may include (or be in communication with) a web server, which can be used, merely by way of example, to process requests for web pages or other electronic documents from user computers 505. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 505 to perform methods of the invention.

The server computers 515, in some embodiments, may include one or more application servers, which can be configured with one or more applications, programs, web-based services, or other network resources accessible by a client. Merely by way of example, the server(s) 515 can be one or more general purpose computers capable of executing programs or scripts in response to the user computers 505 and/or other servers 515, including, without limitation, web applications (which may, in some cases, be configured to perform methods provided by various embodiments). Merely by way of example, a web application can be implemented as one or more scripts or programs written in any suitable programming language, such as Java™, C, C#™ or C++, and/or any scripting language, such as Perl, Python, or TCL, as well as combinations of any programming and/or scripting languages. The application server(s) can also include database servers, including, without limitation, those commercially available from Oracle™, Microsoft™, Sybase™, IBM™, and the like, which can process requests from clients (including, depending on the configuration, dedicated database clients, API clients, web browsers, etc.) running on a user computer, user device, or customer device 505 and/or another server 515.

In accordance with further embodiments, one or more servers 515 can function as a file server and/or can include one or more of the files (e.g., application code, data files, etc.) necessary to implement various disclosed methods, incorporated by an application running on a user computer 505 and/or another server 515. Alternatively, as those skilled in the art will appreciate, a file server can include all necessary files, allowing such an application to be invoked remotely by a user computer, user device, or customer device 505 and/or server 515.

It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 520a-520n (collectively, “databases 520”). The location of each of the databases 520 is discretionary: merely by way of example, a database 520a may reside on a storage medium local to (and/or resident in) a server 515a (or alternatively, user device 505). Alternatively, a database 520n can be remote so long as it can be in communication (e.g., via the network 510) with one or more of these. In a particular set of embodiments, a database 520 can reside in a storage-area network (“SAN”) familiar to those skilled in the art. In one set of embodiments, the database 520 may be a relational database configured to host one or more data lakes collected from various data sources. The databases 520 may include SQL, no-SQL, and/or hybrid databases, as known to those in the art. The database may be controlled and/or maintained by a database server.

The system 500 may further include an ML control system 525, one or more BOPs 530, one or more well/drill sensors 535, and remote ML control system 540. In various embodiments, the ML control system 525 may be coupled, via the network 510, to the one or more well/drill sensors 535 and optionally, in some embodiments, the remote ML control system 540. The ML control system 525 may be further be coupled to one or more BOPs 530. The one or more well/drill sensors 535 may further be coupled to the network 510, through which the one or more well/drill sensors 535 may be coupled to the remote ML control system 540. The one or more BOPs 530 may further be coupled, in some embodiments, to the remote ML control system 540.

As previously described, the ML control system 525 may be configured to obtain operational data from the one or more well/drill sensors 535. The ML control system 525 may be configured to generate one or more feature vectors based on the operational data. The feature vectors may be provided to one or more neural networks, such as a bank of parallel neural networks. The one or more neural networks may respectively generate kick scores based on the respective feature vector. One or more BOP position control processes may then determine whether the kick scores have exceeded respective kick score thresholds and determine an action to perform. Depending on an operational mode, for example, the BOP position control processes may issue position commands to the one or more BOPs 530 and/or provide recommended position commands to a user via the ML control system 525.

In some alternative embodiments, the remote ML control system 540 may be configured determine a position control command to be issued and/or recommended position command to be issued. The remote ML control system 540 may then communicate with, via the network 510, and cause the ML control system 525 to issue the position control command and/or present the recommendation.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to certain structural and/or functional components for ease of description, methods provided by various embodiments are not limited to any single structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in sequentially for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a specific structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to one embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A system comprising:
one or more blowout preventers (BOP);
one or more sensors;
a neural network bank comprising one or more neural networks;
a machine learning (ML) controller coupled to the one or more BOPs, the ML controller comprising:
a processor; and
non-transitory computer readable media comprising instructions executable by the processor to:
obtain, via the one or more sensors, operational data associated with a local well, wherein the operational data is indicative of well conditions and characteristics;
generate one or more feature vectors based on the operational data;
provide the one or more feature vectors to the one or more neural networks;
generate, via the one or more neural networks, one or more respective kick scores;
in a fully automatic operational mode, issue a position command based on the kick score to each of the one or more BOPs; and
in a semi-automatic operational mode, determine the position command recommended to be issued based on the kick score for each of the one or more BOPs.

2. The system of claim 1, wherein the one or more neural networks of the neural network bank comprises one or more parallel pairs of neural networks, each of the one or more parallel pairs of neural networks comprising a deep learning neural network and shallow learning neural network.

3. The system of claim 2, wherein each of the one or more parallel pairs of neural networks is associated with a respective BOP of the one or more BOPs.

4. The system of claim 1, wherein the instructions are further executable by the processor to:
determine whether the one or more respective kick scores exceeds one or more respective kick score thresholds;
wherein in response to determining that the respective kick score threshold has been exceeded, the position command is a close position command configured to cause a respective BOP to close; and
wherein in response to determining that the respective kick score threshold has not been exceeded, the position command is an open position command configured to cause the respective BOP to remain opened.

5. The system of claim 1, wherein the instructions are further executable by the processor to:
determine a respective weight to be assigned to the one or more respective kick scores; and
determine a respective threshold for each of the one or more respective kick scores.

6. The system of claim 1, wherein generating the one or more feature vectors includes generating a respective feature vector for each of a deep learning neural network and a shallow learning neural network.

7. The system of claim 1, wherein the instructions are further executable by the processor to:
obtain one or more of synthetic operational data, remote operational data, and historical data;
generate one or more second feature vectors based on the one or more of synthetic operational data, remote operational data, and historical data;
provide the one or more second feature vectors to the neural networks; and
train the neural networks based on the one or more feature vectors.

8. The system of claim 1 further comprising a BOP digital twin configured to indicate a current state of the one or more BOPs, and a commanded state of the one or more BOPs.

9. The system of claim 8, wherein the instructions are further executable by the processor to:
provide feedback to the BOP digital twin, wherein the feedback includes at least one of the current state of the one or more BOPs, the commanded state of the one or more BOPs, one or more respective kick scores, the position command to be issued or recommended to be issued for each of the one or more BOPs; and
provide, via the BOP digital twin, an alert indicative that a kick score of the one or more respective kick scores has exceeded a respective kick score threshold; and
provide, via the BOP digital twin, an indication of the position command issued or recommended to be issued.

10. The system of claim 1, wherein the ML control system is a remote ML control system coupled to the one or more BOPs via a communications network.

11. An apparatus comprising:
a processor; and
non-transitory computer readable media comprising instructions executable by the processor to:
obtain, via one or more sensors, operational data associated with a local well, wherein the operational data is indicative of well conditions and characteristics;
generate one or more feature vectors based on the operational data;
provide the one or more feature vectors to the one or more neural networks;
generate, via one or more neural networks, one or more respective kick scores;
in a fully automatic operational mode, issue a position command based on the kick score to each of one or more BOPs; and
in a semi-automatic operational mode, recommend the position command to be issued based on the kick score for each of the one or more BOPs.

12. The apparatus of claim 11, wherein the one or more neural networks comprises one or more parallel pairs of neural networks, each of the one or more parallel pairs of neural networks associated with a respective BOP of the one or more BOPs.

13. The apparatus of claim 11, wherein the instructions are further executable by the processor to:
determine whether the one or more respective kick scores exceeds one or more respective kick score thresholds;
wherein in response to determining that the respective kick score threshold has been exceeded, the position command is a close position command configured to cause a respective BOP to close; and
wherein in response to determining that the respective kick score threshold has not been exceeded, the position command is an open position command configured to cause the respective BOP to remain opened.

14. The apparatus of claim 11, wherein the instructions are further executable by the processor to:
identify, via the AI pipeline, feature data of the customer usage data configured to be used by the predictive model to generate the predicted usage data, wherein the feature data includes one or more features of the usage patterns.

15. The apparatus of claim 11, wherein the instructions are further executable by the processor to:
determine a respective weight to be assigned to the one or more respective kick scores; and
determine a respective threshold for each of the one or more respective kick scores.

16. The apparatus of claim 11, wherein generating the one or more feature vectors includes generating a respective feature vector for each of a deep learning neural network and a shallow learning neural network.

17. The apparatus of claim 11, wherein the instructions are further executable by the processor to:
provide feedback to a BOP digital twin, wherein BOP digital twin is configured to indicate a current state of the one or more BOPs, and a commanded state of the one or more BOPs, wherein the feedback includes at least one of the current state of the one or more BOPs, the commanded state of the one or more BOPs, one or more respective kick scores, the position command to be issued or recommended to be issued for each of the one or more BOPs; and
provide, via the BOP digital twin, an alert indicative that a kick score of the one or more respective kick scores has exceeded a respective kick score threshold; and
provide, via the BOP digital twin, an indication of the position command issued or recommended to be issued.

18. A method comprising:
obtaining, via one or more sensors, operational data associated with a local well, wherein the operational data is indicative of well conditions and characteristics;
generating, via a ML control system, one or more feature vectors based on the operational data;
providing, via the ML control system, the one or more feature vectors to the one or more neural networks;
generating, via one or more neural networks, one or more respective kick scores;
in a fully automatic operational mode, issuing, via the ML control system, a position command based on the kick score to each of the one or more BOPs; and
in a semi-automatic operational mode, determining, via the ML control system, a recommended position command to be issued based on the kick score for each of the one or more BOPs.

19. The method of claim 18, wherein the customer usage data further includes usage patterns of one or more network services by the first customer, wherein the predicted usage data further includes prediction of an individual network service of the one or more network services predicted to be used by the first customer, the method further comprising:
provisioning, via the service orchestration server, the individual network service based on the predicted usage data;
wherein turning-up the individual cloud service includes provisioning one or more cloud resources required to provide the individual cloud service, and wherein provisioning the individual network service includes provisioning one or more network resources required to provide the individual network service.

20. The method of claim 18 further comprising:
determining whether the one or more respective kick scores exceeds one or more respective kick score thresholds;
wherein in response to determining that the respective kick score threshold has been exceeded, determining the position command is a close position command configured to cause a respective BOP to close; and
wherein in response to determining that the respective kick score threshold has not been exceeded, determining the position command is an open position command configured to cause the respective BOP to remain opened.
